(19) United States
(12) Patent Application Publication
(10) Pub. No.: US 2026/0003115 A1
(43) Pub. Date: Jan. 1, 2026

(54) WAVEPLATE COMPENSATOR DESIGN

(71) Applicant: KLA Corporation, Milpitas, CA (US)

(72) Inventor: Paul Aoyagi, Sunnyvale, CA (US)

(21) Appl. No.: 18/755,644

(22) Filed: Jun. 26, 2024

(51) Int. Cl. G02B 5/30; G01N 21/95

(52) U.S. Cl. CPC G02B 5/3083; G01N 21/9501

(57) ABSTRACT

A waveplate compensator includes birefringent material layers and spacer layers. Each of the birefringent material layers has a thickness less than or equal to 35 μm. Each adjacent pair of the birefringent material layers in a stack is separated by one of the spacer layers. The birefringent material layers and the spacer layers are disposed in contact with each other using optical contact bonding.

### FIELD OF THE DISCLOSURE

This disclosure relates to optical components and, more particularly, to waveplate compensators.

### BACKGROUND OF THE DISCLOSURE

Evolution of the semiconductor manufacturing industry is placing greater demands on yield management and, in particular, on metrology and inspection systems. Critical dimensions continue to shrink, yet the industry needs to decrease time for achieving high-yield, high-value production. Minimizing the total time from detecting a yield problem to fixing it maximizes the return-on-investment for a semiconductor manufacturer.

Fabricating semiconductor devices, such as logic and memory devices, typically includes processing a semiconductor wafer or other workpiece using a large number of fabrication processes to form various features and multiple levels of the semiconductor devices. For example, lithography is a semiconductor fabrication process that involves transferring a pattern from a reticle to a photoresist arranged on a semiconductor wafer. Additional examples of semiconductor fabrication processes include, but are not limited to, chemical-mechanical polishing (CMP), etching, deposition, and ion implantation. An arrangement of multiple semiconductor devices fabricated on a single semiconductor wafer may be separated into individual semiconductor devices.

In semiconductor metrology, a metrology tool may include an illumination system that illuminates a sample (e.g., a semiconductor wafer, reticle, or other workpiece), a collection system which captures relevant information provided by the illumination system's interaction (or lack thereof) with the sample, device, or feature, and a processing system that analyzes the information collected using one or more algorithms. Metrology tools can be used to measure structural and material characteristics (e.g., material composition, dimensional characteristics of structures and films) associated with various semiconductor fabrication processes. These measurements are used to facilitate process controls and/or yield efficiencies in the manufacture of semiconductor dies.

The metrology tool can perform many different types of measurements related to semiconductor manufacturing. For example, in certain embodiments the tool may measure characteristics of one or more samples, such as critical dimensions, overlay, sidewall angles, film thicknesses, process-related parameters (e.g., focus and/or dose). The samples can include certain regions of interest that are periodic in nature, such as gratings in a memory die. Samples can include multiple layers (or films) whose thicknesses can be measured by the metrology tool. Samples can include target designs placed (or already existing) on the semiconductor wafer or other workpieces for use, such as with alignment and/or overlay registration operations. For example, certain targets can be located at various places on the semiconductor wafer. For example, targets can be located within the scribe lines (e.g., between dies) and/or located in the die itself. In certain embodiments, multiple targets are measured (at the same time or at differing times) by the same or multiple metrology tools. The data from such measurements may be combined. Data from the metrology tool is used in a semiconductor manufacturing process to provide feed-forward, feed-backward, and/or feed-sideways corrections to the process (e.g., lithography or etch).

As semiconductor device pattern dimensions continue to shrink, smaller metrology targets are often required. Furthermore, the measurement accuracy and matching to actual device characteristics can increase the need for device-like targets as well as in-die and even on-device measurements. Various metrology implementations have been proposed to achieve that goal. For example, focused beam ellipsometry based on primarily reflective optics has been proposed. Apodizers can be used to mitigate the effects of optical diffraction causing the spread of the illumination spot beyond the size defined by geometric optics. The use of high-numerical-aperture tools with simultaneous multiple angle-of-incidence illumination is another way to achieve small-target capability. Other measurement examples may include measuring the composition of one or more layers of the semiconductor stack, measuring certain defects on (or within) the wafer, and measuring the amount of photolithographic radiation exposed to the wafer. In some cases, the metrology tool and algorithm may be configured for measuring non-periodic targets.

Some metrology tools use a waveplate compensator. Previous waveplate compensators have poor yield, reduced measurement accuracy, and reduced tool-to-tool matching. Improved designs are needed.

### BRIEF SUMMARY OF THE DISCLOSURE

A waveplate compensator is provided in an embodiment. The waveplate compensator includes birefringent material layers and spacer layers. Each of the birefringent material layers has a non-zero thickness less than or equal to 35 μm. Each adjacent pair of the birefringent material layers in a stack is separated by one of the spacer layers. The birefringent material layers and the spacer layers are disposed in contact with each other using optical contact bonding.

In an instance, each of the spacer layers may be amorphous and/or noncrystalline. In another instance, each of the spacer layers may be at least partially amorphous. For example, each of the spacer layers may be fused silica, fused quartz, or crown glass.

The waveplate compensator can include secondary quartz layers. Each of the secondary quartz layers has a thickness from 40 μm to 50 μm. A pair of the secondary quartz layers are disposed in contact with each other in the stack. Each of the secondary quartz layers is separated from one of the quartz layers in the stack by one of the spacer layers.

In an instance, at least one of the birefringent material layers is quartz. In another instance, at least one of the birefringent material layers is MgF₂, sapphire, or calcite.

The stack may include an adhesive material layer. The adhesive material layer can be in contact with at least one of the birefringent material layers. The adhesive material layer can be separated from at least one of the birefringent material layers by a spacer layer.

The waveplate compensator may include a frame disposed on the stack. The frame can separate two of the birefringent material layers thereby defining a gap between the two of the birefringent material layers.

In an instance, all the birefringent material layers in the stack can be separated from each other by a non-zero distance.

In an instance, a thickness of the spacer layers may be greater than 150 μm. For example, the thickness of the spacer layers may be greater than 500 μm.

The spacer layers may have an index of refraction that is approximately equal to that of the birefringent material layers.

In an embodiment of a method, light is directed at the waveplate compensator.

In another embodiment, a metrology tool includes an illumination source that generates an illumination beam directed at a stage configured to hold a sample, a detector configured to receive a collection beam from the sample on the stage, and at least one waveplate compensator that is in accordance with one of the embodiments herein. The waveplate compensator is disposed in a path of the illumination beam or the collection beam.

### DESCRIPTION OF THE DRAWINGS

For a fuller understanding of the nature and objects of the disclosure, reference should be made to the following detailed description taken in conjunction with the accompanying drawings, in which:

FIG. 1 is a diagram illustrating the mechanical strain between two quartz layers;

FIG. 2 is a diagram of an exemplary metrology tool;

FIG. 3 illustrates a perspective view of a cross-section of an embodiment of a waveplate compensator in accordance with the present disclosure;

FIG. 4 illustrates a cross-sectional view of a second embodiment of a waveplate compensator in accordance with the present disclosure;

FIG. 5 illustrates a cross-sectional view of a third embodiment of a waveplate compensator in accordance with the present disclosure;

FIG. 6 illustrates a cross-sectional view of a fourth embodiment of a waveplate compensator in accordance with the present disclosure;

FIG. 7 illustrates a cross-sectional view of a fifth embodiment of a waveplate compensator in accordance with the present disclosure;

FIG. 8 illustrates a cross-sectional view of a sixth embodiment of a waveplate compensator in accordance with the present disclosure; and

FIG. 9 illustrates a cross-sectional view of a seventh embodiment of a waveplate compensator in accordance with the present disclosure.

### DETAILED DESCRIPTION OF THE DISCLOSURE

Although claimed subject matter will be described in terms of certain embodiments, other embodiments, including embodiments that do not provide all of the benefits and features set forth herein, are also within the scope of this disclosure. Various structural, logical, process step, and electronic changes may be made without departing from the scope of the disclosure. Accordingly, the scope of the disclosure is defined only by reference to the appended claims.

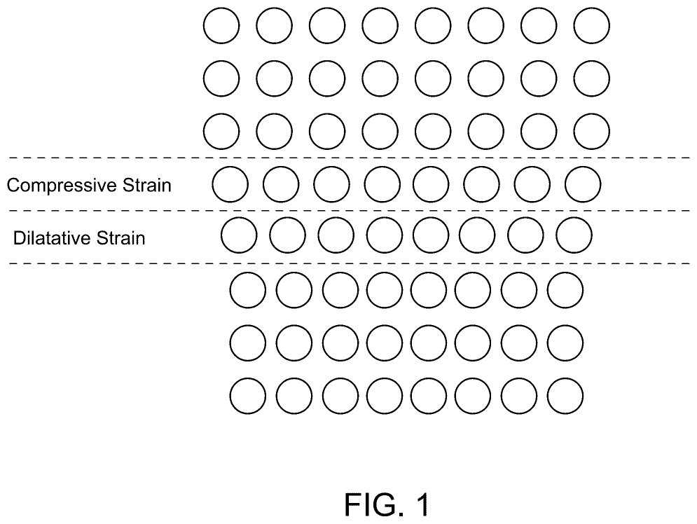

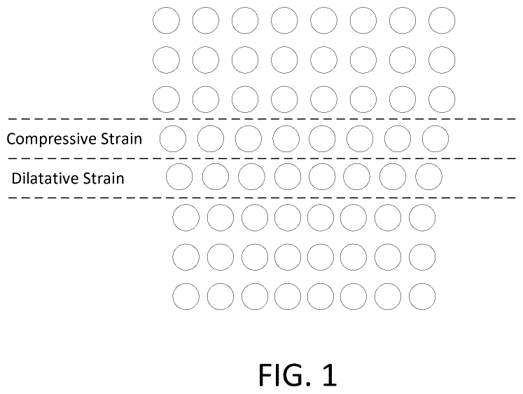

In embodiments disclosed herein, optical contact bonding interfaces between some or all birefringent material layers are eliminated to reduce strain at the interface and the resulting optical distortions. For example, only fused silica-quartz optical contact bonding may be used because the amorphous nature of the fused silica can lessen the strain of lattice dislocation. In another example, optical contact bonding at quartz-quartz interfaces may be used when both quartz layers are sufficiently thick, e.g., >35 μm. The strain at the quartz-quartz optical contact bond tends to be localized to the interface. Thus, strain disappears infinitely far from the interface in the bulk. The problems of previous designs may be caused by modeling errors stemming from unmodeled lattice dislocation strain at the interface of the quartz-to-quartz optical contact bonds. FIG. 1 illustrates a possible mechanical strain distribution induced at a single interface of two materials with different crystal lattice orientations. The top has a larger lattice parameter than the bottom, which results in a compressive strain in the top and a dilatative strain in the bottom. FIG. 1 is simplified to include only a few layers in the lattice.

A waveplate compensator is an optical component that can be difficult to manufacture, particularly, when multiple waveplates must be used to achieve broadband plasma illumination source capability. These waveplate compensators can be a source of tool matching error as evidenced by the fact tool-to-tool spectral matching is often degraded after adding the waveplate compensator to the optical tool. Experiments confirmed that the embodiments disclosed herein can solve the yield issue and improve the tool matching and accuracy.

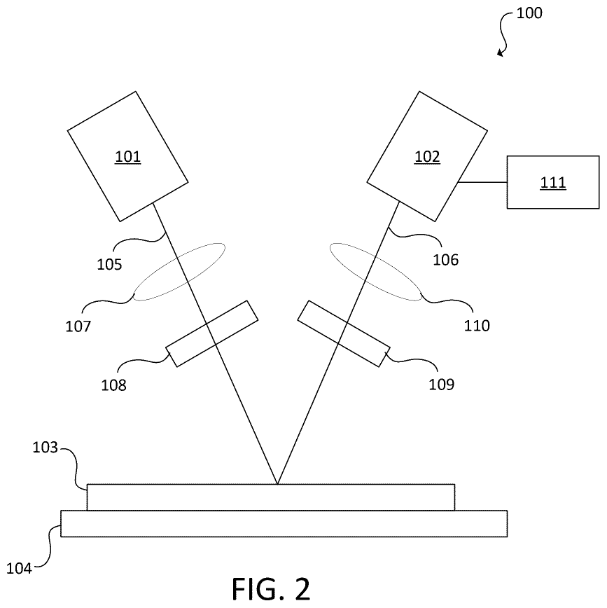

A metrology tool 100 for generating metrology data associated with one or more samples is shown in FIG. 2. The metrology tool 100 may include any type of metrology tool known in the art suitable for providing scatterometry metrology signals at one or more wavelengths. For example, the metrology tool 100 may include, but is not limited to, a spectrometer, a spectroscopic ellipsometer with one or more angles of illumination, a spectroscopic ellipsometer for measuring Mueller matrix elements (e.g., using rotating compensators), a spectroscopic reflectometer, a scatterometer, or a polarimeter. Further, the metrology tool 100 may operate in an imaging or a non-imaging configuration.

The metrology tool 100 may generate metrology data associated with any location on a sample. In an embodiment, the metrology tool 100 generates metrology data for device features on a sample. In this regard, the metrology tool 100 may directly characterize features of interest. In another embodiment, the metrology tool 100 generates metrology data for one or more metrology targets including fabricated features designed to be representative of the device features on the sample. In this regard, measurements of one or more metrology targets distributed across a sample may be attributed to the device features. For example, the size, shape, or distribution of sample features may not be suitable for accurate metrology measurements. In contrast, a metrology target may include features on one or more sample layers having sizes, shapes, and distributions tailored such that metrology data of the target is highly sensitive to one or more selected physical or optical attributes of the features. Metrology data of the target may then be related to specific values of the selected attributes (e.g., through a model).

To enable measurements, metrology targets may be designed to be sensitive to a wide variety of physical or optical attributes including, but not limited to CD, overlay, sidewall angles, film thicknesses, film compositions, or process-related parameters (e.g., focus or dose). To this end, a metrology target may include any combination of periodic structures (e.g., one, two, or three-dimensional periodic structures) or isolated non-periodic features. Further, a metrology target may generally be characterized having one or more spatial frequencies (e.g., one or more pitches) that can be attributed to a pattern or distribution of features. Metrology targets may be located at multiple sites on a sample. For example, targets may be located within scribe lines (e.g., between dies) and/or located in a die itself.

The metrology tool 100 can include a controller 111. The controller 111 includes one or more processors configured to execute program instructions maintained on a memory medium (e.g., memory). In this regard, the one or more processors of controller 111 may execute any of the various process steps described throughout the present disclosure. Further, the memory medium may store any type of data for use by any component of the metrology tool 100. For example, the memory medium may store recipes for the metrology tool 100, metrology data generated by the metrology tool 100. The controller 111 may further perform any number of processing or analysis steps. For example, a metrology target may be modeled (parameterized) using any technique known in the art including, but not limited to, a geometric engine, a process modeling engine, or a combination thereof. The controller 111 may further analyze collected data from the metrology tool 100 using any data fitting and optimization technique known in the art to apply the collected data to the model including, but not limited to libraries, fast-reduced-order models, regression, machine-learning algorithms such as neural networks, support-vector machines (SVM), dimensionality-reduction algorithms (e.g., principal component analysis (PCA), independent component analysis (ICA), or local-linear embedding (LLE)), sparse representation of data (e.g., Fourier or wavelet transforms, Kalman filters, or algorithms to promote matching from same or different tool types).

In some embodiments, the controller 111 analyzes raw data generated by the metrology tool 100 using algorithms that do not include modeling, optimization, and/or fitting (e.g., phase characterization). Computational algorithms performed by the controller 111 may be tailored for metrology applications through the use of parallelization, distributed computation, load-balancing, multi-service support, design and implementation of computational hardware, or dynamic load optimization. Further, various implementations of algorithms may be performed by the controller 111 (e.g., though firmware, software, or field-programmable gate arrays (FPGAs)), or one or more programmable optical elements associated with the metrology tool 100.

The metrology tool 100 can include an illumination source 101 to generate an illumination beam 105. The illumination beam 105 may include one or more selected wavelengths of light such as ultraviolet (UV) radiation, visible radiation, or infrared (IR) radiation. For example, the metrology tool 100 may include an illumination source 101 suitable for generating an illumination beam 105 with wavelengths spanning a range of 120-20,000 nm or any subset or combination of subsets of wavelengths therein.

The metrology system 400 may include any number or type of illumination source 101 known in the art. In an instance, the illumination source 101 include a laser source such as one or more narrowband laser sources, one or more broadband laser sources, one or more supercontinuum laser sources, one or more white light laser sources, or one or more quantum cascade lasers (QCL). In an instance, the illumination source 101 includes one or more light emitting diodes (LEDs). In an instance, the illumination source 101 includes a lamp source such as an arc lamp, a discharge lamp, or an electrode-less lamp. For example, a lamp source, may include, but is not limited to, a Xe lamp source, a deuterium lamp source, or a halogen lamp source. In an instance, the illumination source 101 includes a broadband plasma (BBP) illumination source. In an instance, the illumination source 101 provides a tunable illumination beam 105. For example, the illumination source 101 may include a tunable source of illumination (e.g., one or more tunable lasers). By way of another example, the illumination source 101 may include a broadband illumination source coupled to a tunable filter. The illumination source 101 may further provide an illumination beam 105 having any temporal profile. For example, the illumination beam 105 may have a continuous temporal profile, a modulated temporal profile, or a pulsed temporal profile.

In some embodiments, the illumination source 101 directs the illumination beam 105 to a sample 103 via an illumination pathway and collects light emanating from the sample 103 as a collected beam 106 (e.g., collected light) via a collection pathway. The collected beam 106 may include any combination of light from the sample 103 generated in response to the incident illumination beam 105 such as reflected light, scattered light, diffracted light, or luminescence of the sample 103. In some embodiments, the sample 103 is located on a stage 104, which may include a linear translation stage, a rotational stage, and/or a tip/tilt stage.

In some embodiments, the illumination pathway may include an illumination focusing element 107 to focus the illumination beam 105 onto the sample 103. The illumination pathway may include one or more illumination beam conditioning components 108 suitable for modifying and/or conditioning the illumination beam 105. For example, the one or more illumination beam conditioning components 108 may include one or more polarizers, one or more filters, one or more beam splitters, one or more apodizers, one or more beam shapers, one or more diffusers, one or more homogenizers, or one or more lenses. In some embodiments, the one or more illumination beam conditioning components 108 in the illumination pathway include at least one waveplate compensator.

In some embodiments, the collection pathway may include a collection focusing element 110 to capture the collected beam 106 from the sample 103. In some embodiments, the metrology tool 100 includes a detector 102 configured to detect at least a portion of the collected beam 106 emanating from the sample 103 through the collection pathway. The detector 102 may include any type of optical detector known in the art suitable for measuring illumination received from the sample 103. For example, a detector 102 may include, but is not limited to, a CCD detector, a CMOS detector, a TDI detector, a photomultiplier tube (PMT), or an avalanche photodiode (APD). In some embodiments, a detector 102 may include a spectroscopic detector suitable for identifying wavelengths of radiation emanating from the sample 103. The detector 102 can be in electronic communication with the controller 111.

The collection pathway may further include any number of collection beam conditioning elements 109 to direct and/or modify illumination collected by the collection focusing element 110 including one or more lenses, one or more filters, one or more polarizers, or one or more phase plates. In some embodiments, the one or more collection beam conditioning elements 109 in the collection pathway include at least one waveplate compensator.

The metrology tool 100 depicted in FIG. 2 may facilitate multi-angle illumination of the sample 103. More than one illumination source 101 can be coupled to one or more additional detectors 102. In this regard, the metrology tool 100 depicted in FIG. 2 may perform multiple metrology measurements. In some embodiments, the metrology tool 100 may include multiple detectors 102 to facilitate multiple metrology measurements by the metrology tool 100.

Further, the metrology tool 100 may facilitate multi-angle illumination of the sample 103, such as by using more than one illumination source 101. In this regard, the metrology tool 100 may perform multiple metrology measurements. In some embodiments, one or more optical components may be mounted to a rotatable arm (not shown) pivoting around the sample 103 such that the angle of incidence of the illumination beam 105 on the sample 103 may be controlled by the position of the rotatable arm.

In another embodiment (not illustrated), the metrology tool may use a beam splitter so that an objective lens may simultaneously direct the illumination beam 105 to the sample 103 and capture the collected beam 106 emanating from the sample 103. In this regard, the objective lens may operate in place of or along with the illumination focusing element 107 and/or the collection focusing element 110 of FIG. 2.

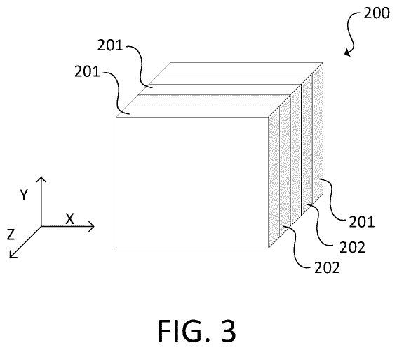

FIG. 3 illustrates a perspective view of a cross-section of an embodiment of a waveplate compensator 200. The waveplate compensator 200 includes spacer layers 201 and birefringent material layers 202. The birefringent material layers 202 in this example are quartz layers 202, but the birefringent material layers in this embodiment or other embodiments also may be, for example, MgF₂, sapphire, calcite, or any birefringent material. Different birefringent material layers in waveplate compensator 200 are not restricted to being of the same material, e.g., some birefringent layers may be quartz while others are MgF₂. Similarly, the spacer layers are not restricted to being of the same material, e.g., some spacer layers 201 may be fused Si while other could be air. The spacer layers 201 and the birefringent material layers 202 are illustrated in FIG. 3 as having generally square shape in the x-y plane. This shape also can be circular, rectangular, or have other features in the x-y plane. The thickness in the z-direction is shown for ease of illustration, but generally the thickness in the z-direction is significantly less than the dimensions in the x-direction or y-direction.

The spacer layers 201 and birefringent material layers 202 form a stack. Light passes through the stack in the, for example, z-direction. While three spacer layers 201 and two birefringent material layers 202 are illustrated in the stack shown in FIG. 3, the number of the spacer layers 201 and birefringent material layers 202 can vary. For example, there may be from 2-4 birefringent material layers 202 with additional spacer layers 201 or 2-8 birefringent material layers 202 with additional spacer layers 201. Larger numbers of birefringent material layers 202 can increase the usable wavelength range of the waveplate compensator 200. However, each layer may increase manufacturing complexity, calibration, and cost.

The birefringent material layers 202 may or may not be in physical contact with each other. In an instance, none of the birefringent material layers 202 are in contact with each other. This avoids quartz-to-quartz optical contact bonding interfaces, which reduces interfacial strain and optical distortions induced by the strain. The birefringent material layers 202 may include of any combination of birefringent materials such as but not limited to quartz, MgF₂, sapphire, and calcite.

The thickness of each of the birefringent material layers 202, in the z-axis can vary. In an instance, each of the birefringent material layers 202 has a non-zero thickness less than or equal to 35 μm in the z-axis (e.g., from 20 μm to 35 μm). A thinner birefringent material layer 202 can increase the usable wavelength range of the waveplate compensator 200. Each of the birefringent material layers can be relatively flat in the x-y plane.

The birefringent material layers 202 each may have birefringence. The birefringent material layers 202 also may be lossless and may have a low index of refraction (i.e., similar to air).

Each of the spacer layers 201 has a non-zero thickness of at least 150 μm in the z-axis. For example, each of the spacer layers 201 may have a thickness of at least 500 μm in the z-axis. A thicker spacer layer 201 can provide increased mechanical strength and may improve the ease of manufacturing. Each of the spacer layers 201 can be relatively flat in the x-y plane.

In an instance, each of the spacer layers 201 is amorphous or at least partially amorphous. An amorphous or partially-amorphous layer may not induce strain on the birefringent material layers 202. The spacer layers 201 can be optically inert and may not affect operation of the waveplate compensator 200. Instead, the spacer layers 201 keep the birefringent material layers from contacting each other and/or breaking. The spacer layers 201 may have an index of refraction that is approximately equal to that of the birefringent material layers (e.g., ±10%, ±5%, or ±1%) with no loss. The birefringent material layer 202 can have a periodic lattice structure, such that the birefringent layer is non-amorphous.

In an embodiment, the birefringent material layers 202 may be made of quartz. Any nearest neighboring quartz layers may be separated by a spacer layer 201 made of fused silica. In another embodiments, the birefringent material layer are made of MgF₂, sapphire, and/or calcite. In embodiments, the spacer layer 201 may be made of fused quartz, crown glass, or other materials.

Some or all of the spacer layers 201 and birefringent material layers 202 are connected using optical contact bonding. Optical contact bonding is a glueless process. Two closely conformal surfaces, like the spacer layers 201 and birefringent material layers 202 of FIG. 3, are joined and held primarily or entirely by intermolecular forces (e.g., Van der Waals forces). The optical contact bonding may result in a stronger bond than glues/adhesive bonding. If the adjacent surfaces are smooth and flat, then the resulting connection using optical contact bonding also can be flatter than using glue.

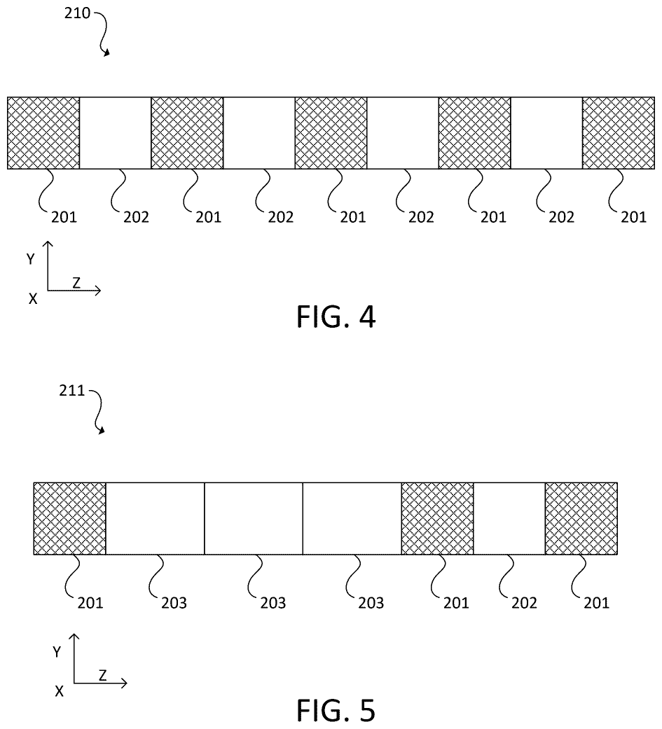

FIG. 4 illustrates a cross-sectional view of another embodiment of a waveplate compensator 210. The stack in FIG. 4 includes nine layers of alternating spacer layers 201 and birefringent material layers 202. No pair of the birefringent material layers 202 comes into contact. More birefringent material layers 202 may result in an increased usable bandwidth of the waveplate compensator 210.

FIG. 5 illustrates a cross-sectional view of another embodiment of a waveplate compensator 211. The stack in FIG. 5 includes a plurality of secondary birefringent material layers. The secondary birefringent material layers 203 are thicker than the birefringent material layers 202. The secondary birefringent material layers 203 may have a thickness of greater than 35 μm (e.g., from 40 μm to 50 μm), but other thicker layers are possible. Each pair of the secondary birefringent material layers 203 are disposed in physical contact with at least one (i.e., one or two) of the other secondary birefringent material layers 203. Bonding between the secondary birefringent material layers 203 may improve transmittivity of light and may improve yield because the number of bonds is reduced with fewer spacer layers 201. The secondary birefringent material layers 203 are all separated from one of the birefringent material layers 202 by one of the spacer layers 201. The secondary birefringent material layers 203 may be bonded to each other or with other layers in the stack using optical contact bonding.

The effect shown in FIG. 1 is generally limited to the interface between two quartz surfaces because the lattice cells are different lengths. Each atom in the lattice tries to fit to its counterpart. However, this effect weakens the farther the atom is from the interface (i.e., the deeper into the bulk). Thus, a thicker birefringent material layer (such as a thicker quartz layer) may not suffer the same problems as a thinner birefringent material layer (such as a thinner quartz layer). If only, for example, 1 nm of the birefringent material layer is affected at the interface when bonding two birefringent material layers, then a smaller percentage of the overall thickness of a birefringent material layer is affected. With a thicker birefringent material layer, a smaller percentage of the thickness means that the overall effect may be negligible for that particular birefringent material layer.

While FIG. 5 is described with quartz, the same principles can be applied to other birefringent materials disclosed herein.

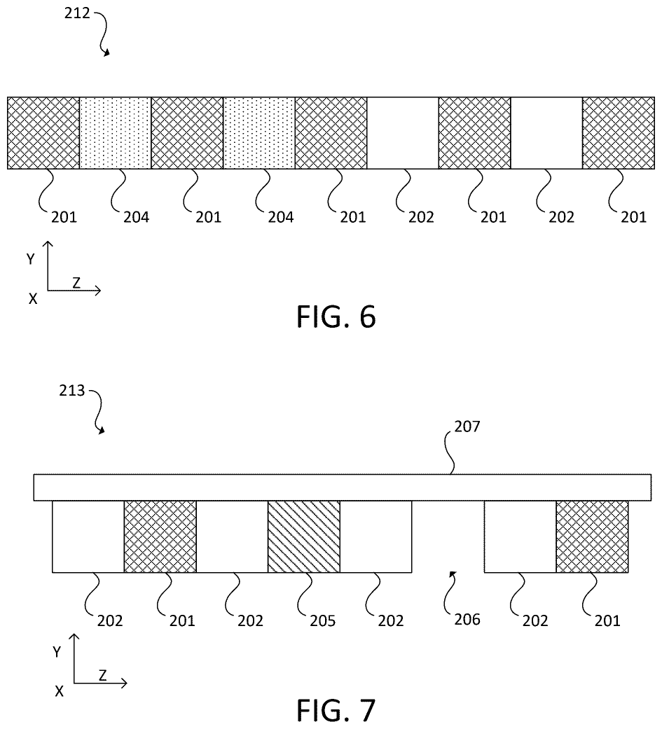

FIG. 6 illustrates a cross-sectional view of another embodiment of a waveplate compensator 212. The stack in FIG. 6 includes another birefringent material layer 204. In an instance, the birefringent material layer 204 includes quartz, MgF₂, sapphire, or calcite. For example, the birefringent material layer 202 may be quartz and the birefringent material layer 204 may be made up of MgF₂, sapphire, or calcite. The birefringent material layer may have a thickness from 20 μm to hundreds of microns. Each of the birefringent material layers 204 is in contact with one or two of the spacer layers 201. Thus, a birefringent material layer 204 can be separated by a birefringent material layer 202 by a spacer layer 201. While illustrated in FIG. 6 as only in contact with the spacer layers 201, a birefringent material layer 204 also can be in contact with a birefringent material layer 202.

FIG. 7 illustrates a cross-sectional view of another embodiment of a waveplate compensator 213. The stack in FIG. 7 includes an adhesive spacer layer 205 made of adhesive and an air spacer layer 206 made of air, i.e., an air gap. While illustrated together, in an embodiment, spacer layers may be made up entirely of adhesive spacer layers 205 or entirely of air spacer layers 206. The adhesive spacer layer 205 and the air spacer layer 206 are examples of a spacer layer 201. The spacer layers 201, can be any nonbirefringent materials, are amorphous (i.e., noncrystalline).

The adhesive spacer layer 205 is in contact with one or two birefringent material layers 202. The adhesive spacer layer 205 also may be in contact with a spacer layer 201, in which case the spacer layer 201 separates the adhesive spacer layer 205 and a birefringent material layer 202. The adhesive spacer layer 205 can be a glue. The thickness of the adhesive spacer layer 205 may be approximately 10 μm, but other thicknesses are possible.

To position the layers of the stack, a frame 207 is positioned on at least one side of the stack. The frame 207 can hold the layers apart to form the air spacer layer 206. In FIG. 7, the air spacer layer 206 separates two quartz layers birefringent material layers 202 (which may be two quartz layers). While shown only on one surface of the stack, the frame 207 can be on multiple surfaces or can surround the stack. While an air spacer layer 206 is described, the gap also may be at low atmosphere or vacuum. The air spacer layer 206 may define a distance from hundreds of microns to several millimeters, which can be based on mechanical needs.

In an instance, the frame 207 contacts the edges of the stack using thin quartz layers in physical contact with planar aluminum plates for mechanical strength. Holes in the aluminum plates create the air spacer layer 206 and allow light to pass through as if the aluminum was not there. The air spacer layer 206 can provide a higher power damage threshold because optical contact and adhesive bonding may degrade and affect performance.

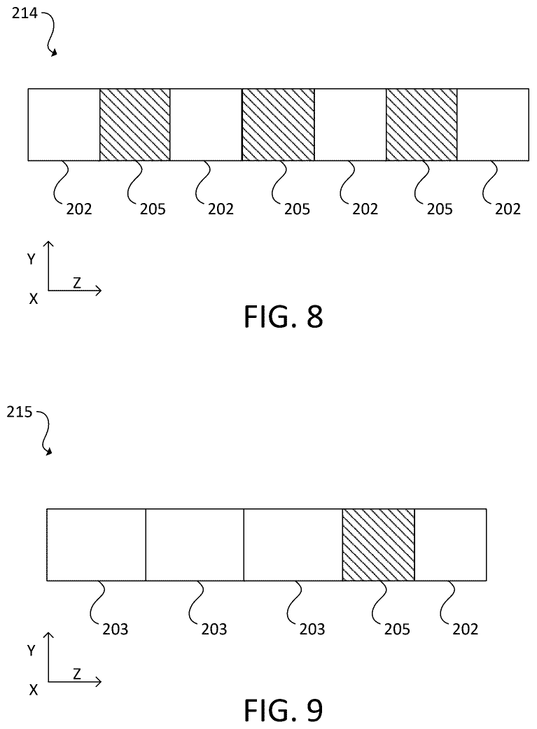

FIG. 8 illustrates a cross-sectional view of another embodiment of a waveplate compensator 214. In FIG. 8, the stack includes birefringent material layers 202 held together using adhesive spacer layers 205. This avoids optical contact bonding, instead relying on the adhesive spacer layers 205 to hold the stack together. The adhesive spacer layers 205 may be easier to use during fabrication than optical contact bonding with certain designs.

FIG. 9 illustrates a cross-sectional view of another embodiment of a waveplate compensator 215. The stack includes three secondary birefringent material layers 203, made of quartz, held together by optical contact bonding. A birefringent material layer 202, made of quartz, is held in the stack using an adhesive spacer layer 205, which connects the quartz layer 202 to one of the secondary quartz layers 203.

The various material layers disclosed herein can be combined together. A waveplate compensator is not limited merely to the embodiments illustrated herein. For example, a birefringent material layer 204 can be combined with an air spacer layer 206 or an adhesive spacer layer 205 can be combined with a secondary birefringent material layer 203, such as a quartz layer 203.

The embodiments disclosed herein can be used with many different semiconductor metrology applications. The waveplate compensator designs can be used with various hardware configurations, software architectures, and use applications beyond those described herein. In an example, light is directed at an embodiment of the waveplate compensator designs described herein.

Although the present disclosure has been described with respect to one or more particular embodiments, it will be understood that other embodiments of the present disclosure may be made without departing from the scope of the present disclosure. Hence, the present disclosure is deemed limited only by the appended claims and the reasonable interpretation thereof.

1. A waveplate compensator comprising:
a plurality of birefringent material layers, wherein each of the birefringent material layers has a non-zero thickness less than or equal to 35 μm; and
a plurality of spacer layers, wherein each adjacent pair of the birefringent material layers in a stack is separated by one of the spacer layers, and wherein the birefringent material layers and the spacer layers are disposed in contact with each other using optical contact bonding.

2. The waveplate compensator of claim 1, wherein each of the spacer layers is amorphous.

3. The waveplate compensator of claim 1, wherein each of the spacer layers is noncrystalline.

4. The waveplate compensator of claim 1, wherein each of the spacer layers is at least partially amorphous.

5. The waveplate compensator of claim 1, wherein each of the spacer layers is fused silica, crown glass, air, or adhesive.

6. The waveplate compensator of claim 1, further comprising a plurality of secondary birefringent material layers, wherein each of the secondary birefringent material layers has a thickness greater than 35 μm, wherein a pair of the secondary birefringent material layers are in physical contact with each other in the stack, but not in physical contact with birefringent material layers that have a thickness less than 35 μm.

7. The waveplate compensator of claim 1, wherein at least one of the birefringent material layers is quartz.

8. The waveplate compensator of claim 1, wherein at least one of the birefringent material layers is MgF₂, sapphire, or calcite.

9. The waveplate compensator of claim 1, wherein the stack includes one or more of the birefringent material layers and/or one or more of the spacer layers.

10. (canceled)

11. (canceled)

12. The waveplate compensator of claim 1, further comprising a frame disposed on the stack, wherein the frame separates two of the birefringent material layers thereby defining an air spacer layer between the two of the birefringent material layers.

13. (canceled)

14. The waveplate compensator of claim 1, wherein a thickness of the spacer layers is greater than 150 μm.

15. (canceled)

16. (canceled)

17. (canceled)

18. A metrology tool comprising:
an illumination source that generates an illumination beam directed at a stage configured to hold a sample;
a detector configured to receive a collection beam from the sample on the stage; and
the waveplate compensator of claim 1, wherein the waveplate compensator is disposed in a path of the illumination beam or the collection beam.
